(19) United States
(12) Patent Application Publication
(10) Pub. No.: US 2025/0104369 A1
(43) Pub. Date: Mar. 27, 2025

(54) INFORMATION PROCESSING METHOD, INFORMATION PROCESSING DEVICE, AND NON-TRANSITORY COMPUTER READABLE RECORDING MEDIUM

(71) Applicant: Panasonic Intellectual Property Corporation of America, Torrance, CA (US)

(72) Inventors: Minami NAKA, Osaka (JP); Satoshi MATSUI, Kyoto (JP); Tadamasa TOMA, Osaka (JP)

(21) Appl. No.: 18/973,716

(22) Filed: Dec. 9, 2024

Related U.S. Application Data
(63) Continuation of application No. PCT/JP2023/020406, filed on Jun. 1, 2023.

(30) Foreign Application Priority Data
Jun. 10, 2022 (JP) 2022-094576

(51) Int. Cl. G06T 19/00; G06T 7/00; G06T 7/80

(52) U.S. Cl. CPC G06T 19/006; G06T 7/0004; G06T 7/80; G06T 2207/10016; G06T 2207/30196; G06T 2207/30204

(57) ABSTRACT

An information processing device constructs, in a virtual space, a three-dimensional (3D) model of a target object to be worked on by a worker in a real space, acquires position information and orientation information of the worker in the real space, synchronizes a position and an orientation of a virtual camera in the virtual space with a position and an orientation of the worker based on the position information and the orientation information, generates a virtual camera video which shows the 3D model captured by the synchronized virtual camera, and outputs output information for displaying an output image that includes the virtual camera video.

### FIELD OF INVENTION

The present disclosure relates to a technique of supporting a work of a worker.

### BACKGROUND ART

Patent Literature 1 discloses a three-dimensional (3D) model generation device that generates a 3D model of a subject by a volume intersection method based on camera videos of a zoom-in camera and a zoom-out camera, in which the 3D model is generated assuming that the subject exists outside an angle of view range of the zoom-in camera.

However, Patent Literature 1 merely generates a virtual camera video closed in a virtual space, and does not have a function of generating a virtual camera video associated with a real space. In this case, under the condition that a video at a work site cannot be output, a remote manager cannot confirm the place looked at by the worker, and thus further improvement is required.

Patent Literature 1: JP 2022-29730 A

### SUMMARY OF THE INVENTION

The present disclosure is intended to solve such a problem, and an object of the present disclosure is to provide a technique of causing a remote manager to confirm a place looked at by a worker under a condition that a video at a work site cannot be output.

An information processing method according to an aspect of the present disclosure is an information processing method in an information processing system that supports a work of a worker, the method including constructing, in a virtual space, a three-dimensional (3D) model of a target object to be worked on by the worker in a real space, acquiring position information and orientation information of the worker in the real space, synchronizing a position and an orientation of a virtual camera in the virtual space with a position and an orientation of the worker based on the position information and the orientation information, generating a virtual camera video indicating the 3D model captured by the virtual camera synchronized, and outputting output information for displaying an output image including the virtual camera video.

The present disclosure can cause the remote manager to confirm the place looked at by the worker under the condition where a video at the work site cannot be output.

### BRIEF DESCRIPTION OF THE DRAWINGS

FIG. 1 is a block diagram illustrating one example of an overall configuration of an information processing system according to a first embodiment of the present disclosure.

FIG. 2 is a diagram illustrating an outline of processing of the information processing system.

FIG. 3 is a diagram illustrating an example of a real space representing a site.

FIG. 4 is a diagram illustrating a state of spatial calibration.

FIG. 5 is a diagram illustrating a state of spatial calibration subsequent to FIG. 4.

FIG. 6 is a diagram illustrating an example of a virtual camera video included in an output image.

FIG. 7 is a flowchart illustrating an overview of the processing of the information processing system.

FIG. 8 is a flowchart illustrating details of processing of the spatial calibration.

FIG. 9 is a flowchart illustrating details of steady state processing.

FIG. 10 is a flowchart illustrating details of synchronization processing.

FIG. 11 is a diagram illustrating an example of an overhead view image.

FIG. 12 is a view illustrating an overhead view image displayed on each of a manager terminal and a worker terminal.

FIG. 13 is a flowchart illustrating processing of spatial calibration in a first modification of the first embodiment.

FIG. 14 is a flowchart illustrating an example of synchronization processing in the first modification of the first embodiment.

FIG. 15 is a flowchart illustrating processing of spatial calibration in a second modification of the first embodiment.

FIG. 16 is an explanatory diagram of processing in the second modification of the first embodiment.

FIG. 17 is an explanatory diagram of processing in the second modification of the first embodiment.

FIG. 18 is an explanatory diagram of processing in the second modification of the first embodiment.

FIG. 19 is a block diagram illustrating an example of a configuration of an information processing system according to a second embodiment.

FIG. 20 is a flowchart illustrating processing of spatial calibration according to the second embodiment.

FIG. 21 is a flowchart illustrating details of steady state processing according to a third embodiment.

FIG. 22 is a block diagram illustrating an example of a configuration of an information processing system according to the third embodiment.

FIG. 23 is a flowchart illustrating details of processing of spatial calibration according to the third embodiment.

FIG. 24 is a flowchart illustrating details of the steady state processing according to the third embodiment.

### DETAILED DESCRIPTION

### Knowledge Underlying Present Disclosure

When a worker performs a work on a target object at a work site, the worker may proceed with the work while confirming an instruction from a manager outside the work site. In this case, if the manager can confirm which part of the target object the worker is looking at, the manager can smoothly instruct the worker. In order to achieve this situation, for example, when an imaging device such as an action camera or a smart glass is attached to the head of the worker and a video of the work site captured by the imaging device is transmitted in real time to a manager terminal of the manager, the manager can confirm which part of the target object the worker is looking at.

However, at some work sites, it is prohibited to output of a video to the outside from the viewpoint of security. In this case, there is a problem that the manager cannot confirm the part looked at by the worker.

The present disclosure has been made in order to solve such a problem.
(1) An information processing method according to an aspect of the present disclosure is an information processing method in an information processing system that supports a work of a worker, the method including constructing, in a virtual space, a three-dimensional (3D) model of a target object to be worked on by the worker in a real space, acquiring position information and orientation information of the worker in the real space, synchronizing a position and an orientation of a virtual camera in the virtual space with a position and an orientation of the worker based on the position information and the orientation information, generating a virtual camera video indicating the 3D model captured by the virtual camera synchronized, and outputting output information for displaying an output image including the virtual camera video.

In this configuration, the position and the orientation of the virtual camera are synchronized with the position and the orientation of the worker in the real space, and the virtual camera video in which the 3D model of the target object is captured by the synchronized virtual camera is generated. Accordingly, the manager can confirm the virtual camera video that is the video of the 3D model viewed from the line of sight of the worker. As a result, the place looked at by the worker can be confirmed by the remote manager under the condition where a video at the work site cannot be output.
(2) In the information processing method according to (1), the position information and the orientation information may be real marker information indicating a position and an orientation of a real marker worn by the worker, and the method may further include acquiring initial marker information indicating a position and an orientation of the real marker installed in the real space, executing spatial calibration that associates the real space with the virtual space based on the initial marker information and a relative position of the target object and the real marker, acquiring the real marker information indicating the position and the orientation of the real marker worn by the worker in the real space, and synchronizing the position and the orientation of the virtual camera with the position and the orientation of the real marker indicated by the real marker information based on the real marker information.

In this configuration, the initial marker information indicating the position and the orientation of the real marker is acquired, and the spatial calibration of associating the real space with the virtual space is executed based on the initial marker information and the relative position of the target object and the real marker. Therefore, the real space and the virtual space can be accurately associated with each other, and it is therefore possible to generate the virtual camera video in which the place looked at by the worker is accurately reproduced without using a real video of the work site.
(3) In the information processing method according to (1) or (2), the spatial calibration may include installing a virtual marker corresponding to the real marker at an arbitrary position in the virtual space based on the initial marker information, installing the 3D model in the virtual space with reference to the virtual marker so as to maintain a relative positional relationship between the real marker and the target object based on the relative position, and generating calibration information including a real reference vector indicating a relative position of the real marker with respect to the target object when the spatial calibration is executed and a virtual reference vector indicating a relative position of the virtual marker with respect to the 3D model.

In this configuration, the 3D model is installed in the virtual space with reference to the virtual marker such that the position of the real marker is installed at an arbitrary position in the virtual space and the relative positional relationship between the real marker and the target object is maintained. Therefore, a coordinate system of the virtual space can be set such that the position of the virtual marker substantially becomes an origin, and the position of the target object can be determined by using the coordinate system. Therefore, the real marker and the virtual marker can be accurately associated in an environment using a sensor that represents the position of the real marker by a relative position from the real marker. Since the real reference vector and the virtual reference vector are generated as the calibration information, the virtual camera and the real marker can be accurately synchronized by using the real reference vector and the virtual reference vector at the time of the work.
(4) In the information processing method according to (3), the synchronizing may include calculating a real space vector indicating a relative position of the real marker with respect to the target object based on the real marker information, calculating a difference vector between the real space vector and the real reference vector, determining a position of the virtual marker with respect to the 3D model based on the virtual reference vector and the difference vector and determining an orientation of the virtual marker based on the orientation of the real marker included in the real marker information, determining the position of the virtual marker as the position of the virtual camera, and setting the orientation of the virtual marker as the orientation of the virtual camera.

In this configuration, at the time of the work, the coordinate system of the virtual space can be set such that the position of the virtual marker installed at the time of calibration substantially becomes the origin, and the position of the virtual marker can be determined by using the coordinate system. Therefore, the real marker and the virtual marker can be accurately associated during the work in an environment using a sensor that represents the position of the real marker by a relative position from the real marker.
(5) In the information processing method according to (3), the initial marker information and the real marker information may be information acquired by using a method of sensing a surrounding environment and detecting a relative position of the initial marker information and the real marker information.

In this configuration, the real marker and the virtual marker can be accurately associated in an environment where the position of the real marker is detected by using a method of sensing the surrounding environment and detecting the relative position of the real marker. An example of such a sensor is an inertial sensor or a sensor using SLAM technique.
(6) In the information processing method according to (2), the spatial calibration may include installing a virtual marker corresponding to the real marker in the virtual space based on the initial marker information, installing the 3D model in the virtual space so as to maintain the relative positional relationship between the real marker and the target object based on the relative position, and generating, as the calibration information, a coordinate of the 3D model installed.

In this configuration, the 3D model is installed in the virtual space so as to maintain the relative positional relationship between the real marker and the target object, and a coordinate of the installed 3D model is generated as the calibration information. Therefore, in an environment where the position of the real marker is detected by using the sensor that represents the position of an object by the coordinate system of the real space, the position and the orientation of the virtual marker can be set by directly using the position and the orientation indicated by the real marker information.
(7) In the information processing method according to (6), the synchronizing may include determining the position of the real marker as the position of the virtual camera, and determining the orientation of the real marker as the orientation of the virtual camera.

In this configuration, in an environment where the position of the real marker is detected by using the sensor that represents the position of an object by the coordinate system of the real space, the position and the orientation of the virtual marker can be set by directly using the position and the orientation indicated by the real marker information.
(8) In the information processing method according to (6), the initial marker information and the real marker information may be information acquired by using a sensor representing a position of an object by using a coordinate system of the real space.

In this configuration, the real marker and the virtual marker can be accurately associated in an environment where the position of the real marker is detected by using a sensor that represents the position of an object by using the coordinate system of the real space. An example of such a sensor is an optical sensor.
(9) In the information processing method according to any one of (2) to (8), the initial marker information may include first initial marker information indicating a position and an orientation of a first real marker installed at a position different from a position of the target object, and second initial marker information indicating a position and an orientation of a second real marker installed at the position of the target object, and the spatial calibration may include installing a first virtual marker corresponding to the first real marker in the virtual space based on the first initial marker information, and installing a second virtual marker corresponding to the second real marker in the virtual space so as to maintain a relative positional relationship between the first real marker and the second real marker based on the second initial marker information.

In this configuration, the first real marker and the first virtual marker can be accurately associated by using the first real marker and the second real marker.
(10) In the information processing method according to claim (9), the synchronizing may include determining the position of the first real marker as the position of the virtual camera, and determining the orientation of the first real marker as the orientation of the virtual camera.

In this configuration, in an environment where the position of the real marker is detected by using the sensor that represents the position of an object by the coordinate system of the real space, the position and the orientation of the virtual marker can be set by directly using the position and the orientation indicated by the real marker information.
(11) In the information processing method according to any one of (1) to (10), the virtual camera video may further change in synchronization with a change in the position and the orientation of the virtual camera.

In this configuration, since the virtual camera video is changed in synchronization with the change in the position and the orientation of the virtual camera, the virtual camera video indicating the place looked at by the worker in real time can be obtained.
(12) In the information processing method according to (1) to (11), the output image may further include an overhead view image of the 3D model and a camera icon displayed in association with the overhead view image, and a display mode of the camera icon may be changed in synchronization with the position and the orientation of the virtual camera.

In this configuration, it is possible to provide information indicating which part of the target object the worker is looking at in an overhead view.
(13) In the information processing method according to (12), the output image may be displayed on a worker terminal of the worker and a manager terminal of a manager, and the method may further include acquiring, from the manager terminal, display object information for displaying a display object indicating a position designated by the manager in the overhead view image or the 3D model indicated in the virtual camera video, and displaying the display object to be superimposed on the overhead view image or the virtual camera video based on the display object information.

In this configuration, since the display object indicating the position designated by the manager is displayed to be superimposed on the overhead view image or the virtual camera video, the manager can share the position designated by the manager with the worker.
(14) In the information processing method according to any one of (1) to (13), the 3D model may include a body and a movable portion attached to the body, the method may further include acquiring, from the manager terminal, operation information indicating an operation from the manager for the movable portion, and an image indicating the movable portion included in the virtual camera video may change based on the operation information.

In this configuration, the manager can remotely operate the movable portion of the 3D model.
(15) In the information processing method according to any one of (2) to (8), the initial marker information and the real marker information may be information acquired from a sensor that allows detection of the position and the orientation of the real marker.

In this configuration, the initial marker information and the real marker information can be obtained by measuring the position and the orientation of the real marker by using the sensor.
(16) An information processing device according to another aspect of the present disclosure is an information processing device that supports a work of a worker, the information processing device including a construction unit that constructs, in a virtual space, a three-dimensional (3D) model of a target object to be worked on by the worker in a real space, a first acquisition unit that acquires position information and orientation information of the worker in the real space, a synchronization unit that synchronizes a position and an orientation of a virtual camera in the virtual space with a position and an orientation of the worker based on the position information and the orientation information, and a generation unit that generates a virtual camera video indicating the 3D model captured by the virtual camera synchronized, and an output unit that outputs output information for displaying an output image including the virtual camera video.

In this configuration, it is possible to provide the information processing device that generates the virtual camera video in which the place looked at by the worker is accurately reproduced without using the real video of the work site.

An information processing program according to another aspect of the present disclosure is an information processing program that causes a computer to function as an information processing system that supports a work of a worker, the program causing the computer to execute processing of constructing, in a virtual space, a three-dimensional (3D) model of a target object to be worked on by the worker in a real space, acquiring position information and orientation information of the worker in the real space, synchronizing a position and an orientation of a virtual camera in the virtual space with a position and an orientation of the worker based on the position information and the orientation information, generating a virtual camera video indicating the 3D model captured by the virtual camera synchronized; and outputting output information for displaying an output image including the virtual camera video.

In this configuration, it is possible to provide the information processing program that generates the virtual camera video in which the place looked at by the worker is accurately reproduced without using the real video of the work site.

The present disclosure can be also implemented as an information update system that is operated by such an information processing program. It is needless to say that such a computer program can be distributed via a computer-readable non-transitory recording medium such as a CD-ROM, or via a communication network such as the Internet.

Each of embodiments described below illustrates a specific example of the present disclosure. Numerical values, shapes, components, steps, an order of steps, and the like shown in the embodiments below are one example, and are not intended to limit the present disclosure. Furthermore, a component that is not described in an independent claim representing the highest concept among components in the embodiments below will be described as an arbitrary component. In all the embodiments, respective contents can be combined.

### First Embodiment

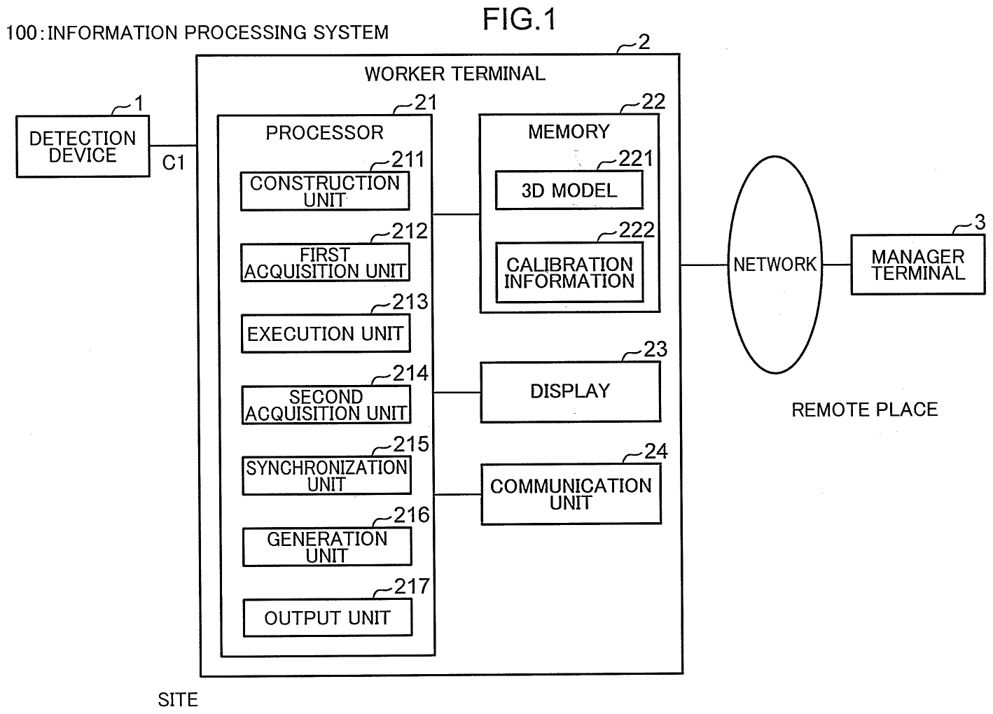

FIG. 1 is a block diagram illustrating one example of an overall configuration of an information processing system 100 according to a first embodiment of the present disclosure. The information processing system 100 is a system in which a manager in a remote place supports a worker who works on a target object. Specifically, the system reproduces an image visually recognized by a worker at a site in a virtual space, and allows a manager to visually recognize a video of the virtual space. The system thus supports a work of the worker from a remote place while sharing information between the worker and the manager.

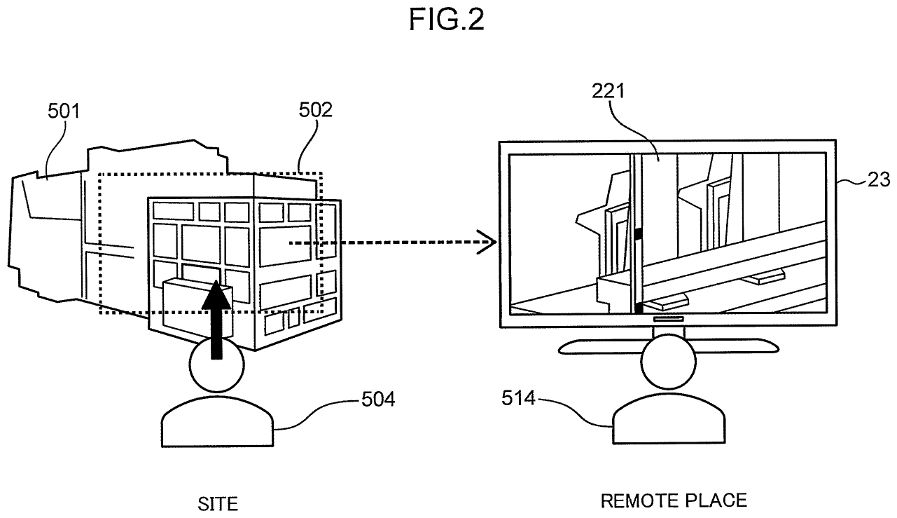

FIG. 2 is a diagram illustrating an outline of processing of the information processing system 100. In FIG. 2, the left diagram illustrates a site, and the right diagram illustrates a remote place. A target object 501 is installed at the site. The worker 504 performs some work on the target object 501 at the site. The information processing system 100 reproduces such an image in a visual field 502 in the virtual space. Specifically, the information processing system 100 constructs a three-dimensional (3D) model 221 simulating the target object 501 in the virtual space, and images the 3D model 221 with a virtual camera disposed in the virtual space to generate a virtual camera video. The generated virtual camera video is displayed on a display of a manager terminal 3 at a remote place. Here, the virtual camera changes an orientation in the virtual space in synchronization with a change in the line of sight of the worker 504 to capture the virtual camera video. As a result, the manager 514 who visually recognizes the virtual camera video can confirm what kind of place in the target object 501 the worker 504 is watching. As a result, the manager 514 can appropriately support the worker. Note that the information processing system 100 may display a gaze point of the worker 504 to be superimposed on the virtual camera video.

The site is, for example, a real space in which the target object is installed. Examples of the site include a factory, an experiment site, a test site, and a chemical plant. The factory may be a factory that manufactures electrical products such as televisions and washing machines, or may be a factory that manufactures automobiles, iron, and the like. These sites are examples, and may be any place as long as the worker performs a work on the target object. For example, the site may be a place where maintenance of equipment or facility is performed.

An example of the target object is a facility to be maintained and a product manufactured on a manufacturing line. Examples of the product include an electrical appliance and an automobile. Examples of the equipment include a manufacturing line of a factory. Hereinafter, the configuration of the information processing system 100 will be specifically described. See FIG. 1. The information processing system 100 includes a detection device 1, a worker terminal 2, and the manager terminal 3. The detection device 1 and the worker terminal 2 are at a site where the target object 501 is installed. The manager terminal 3 is at a remote place. The detection device 1 and the worker terminal 2 are communicably connected via a communication channel C1. The communication channel C1 may be a wireless communication channel such as a wireless LAN or Bluetooth (registered trademark), or may be a wired communication channel. The worker terminal 2 and the manager terminal 3 are connected via a network. The network is a wide-area communication network including the Internet, for example.

The detection device 1 is a sensor installed at a site and capable of detecting a position and an orientation of a real marker installed at the site.

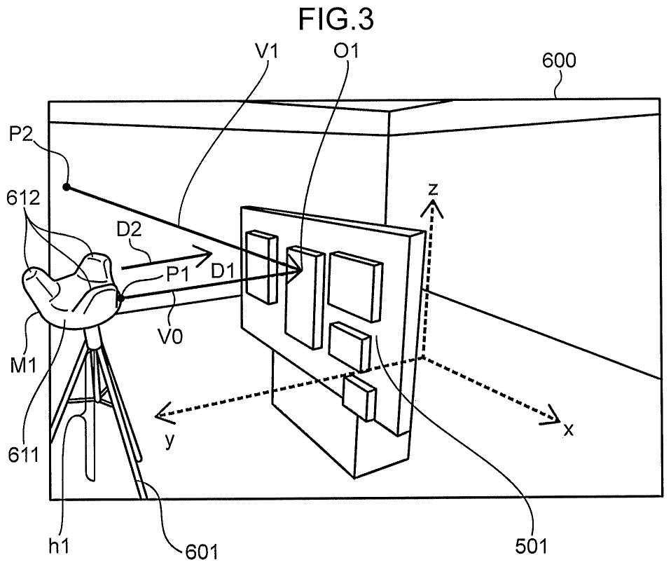

The real marker is an object used to execute spatial calibration that associates the real space and the virtual space. FIG. 3 is a diagram illustrating an example of a real space 600 representing the site. In the real space 600, a real marker M1 and the target object 501 are installed. The real marker M1 includes a base 611 and three protrusions 612 protruding upward from the base 611. A stand 601 that holds the height of the real marker M1 from the ground at a constant height is attached to the base 611. Note that the shape of the real marker M1 illustrated here is an example and is not limited, and other shapes may be adopted.

The detection device 1 may be any sensor device that detects the position and the orientation of the real marker M1. In the first embodiment, the detection device 1 is a sensor that detects the surrounding environment and detects the position of the detection device 1. An example of such a method of estimating the self-position is a method using a simultaneous localization and mapping (SLAM) technique using a camera image or LiDAR. In addition, in the first embodiment, the detection device 1 may be a sensor (inertial sensor) used in an inertial motion capture system or a sensor (magnetic sensor) used in a magnetic motion capture system.

The detection device 1 outputs marker information indicating the position and the orientation of the detected real marker M1 to the worker terminal 2. The position of the real marker M1 is represented by, for example, 3D vector data of the target object 501 or 3D vector data with an initial position as a reference.

The detection device 1 outputs the marker information to the worker terminal 2 via the communication channel C1.

The detection device 1 has been described above. Next, the worker terminal 2 will be described. The worker terminal 2 includes a processor 21, a memory 22, a display 23, and a communication unit 24. The worker terminal 2 is, for example, a portable information terminal carried by the worker. Examples of the portable information terminal include a smartphone, a tablet computer, and a smart glass.

The processor 21 includes, for example, a central processing unit. The processor 21 includes a construction unit 211, a first acquisition unit 212, an execution unit 213, a second acquisition unit 214, a synchronization unit 215, a generation unit 216, and an output unit 217. The construction unit 211 to the output unit 217 may be implemented by the central processing unit executing an information processing program for causing a computer to function as the worker terminal 2, or may be implemented by a dedicated hardware circuit.

The construction unit 211 constructs the 3D model 221 of the target object 501 to be worked on by the worker in the real space in a 3D virtual space. The construction unit 211 is a 3D model that simulates the shape of the target object 501. The construction unit 211 is only required to acquire 3D computer-aided design (CAD) data of the target object 501 or (BIM) building information modeling data of the target object 501, and generate the acquired 3D CAD data or BIM data as the 3D model 221.

Alternatively, the construction unit 211 may generate the target object 501 including a body and a movable portion attached to the body. The movable portion is a 3D model configured to be movable based on operation information indicating an operation input to the manager terminal 3 by the manager 514. In this case, the 3D model 221 is generated by using, for example, a game engine. The construction unit 211 may generate the 3D model 221 by using a volume intersection method. The 3D model 221 may be point cloud data or voxel data. The construction unit 211 stores the generated 3D model 221 in the memory 22.

The first acquisition unit 212 acquires initial marker information indicating the position and the orientation of the real marker M1 in the real space 600. See FIG. 3. In the real space 600, the real marker M1 is installed at a position away from the target object 501 by a reference distance D1 and at a reference height h from the ground. The real marker M1 is installed such that an orientation D2 is parallel to the ground. The orientation D2 is represented by a 3D vector indicating the orientation of the real marker M1. The real marker M1 is installed at a position where the orientation D2 is parallel to a front direction (not illustrated) of the target object 501. The real marker M1 is installed such that a straight line extending from a position P1 in the direction of the orientation D2 intersects a center position O1 of the target object 501. The position P1 is, for example, a front position of the real marker M1. The front position is a center position in front of the real marker M1 facing the target object 501.

The front direction of the target object 501 is a direction parallel to the ground and orthogonal to a main surface. The center position O1 is a position where the height from the ground is the reference height h, and is a position of a center of the target object 501 in a lateral direction. In the example of FIG. 3, the target object 501 is a television in which an internal circuit board is exposed. The reference distance D1 is, for example, an arbitrary distance such as 50 cm or 1 m. The worker 504 performs the work such as assembling parts to the target object 501.

In the real space 600, a relative position of the real marker M1 with respect to the target object 501 is determined in advance. Relative position information indicating the relative position is stored in the memory 22 in advance. The relative position information includes, for example, the reference distance D1.

The initial marker information is marker information detected by the detection device 1 at the time of executing the spatial calibration. The spatial calibration is executed before the worker 504 performs the work. In the spatial calibration, the detection device 1 detects the position and the orientation of the real marker M1 installed at a predetermined relative position with respect to the target object 501 as illustrated in FIG. 3, and outputs marker information indicating the detected position and orientation to the worker terminal 2. The first acquisition unit 212 acquires the marker information output from the detection device 1 as the initial marker information at the time of executing the spatial calibration.

The execution unit 213 executes the spatial calibration for associating the real space 600 with the virtual space based on the initial marker information and the relative position information stored in the memory 22. Details of the spatial calibration are as follows.

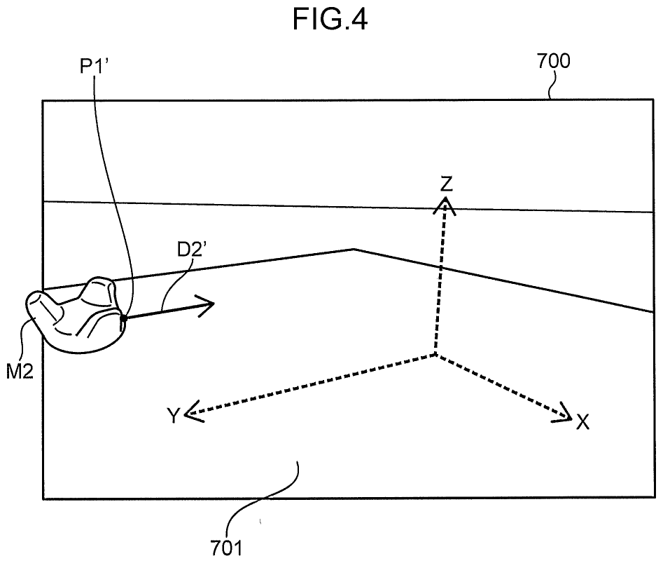

FIG. 4 is a diagram illustrating a state of the spatial calibration. First, the execution unit 213 installs a virtual marker M2 corresponding to the real marker M1 in a virtual space 700 based on the initial marker information. The virtual marker M2 is a 3D model simulating the real marker M1. The virtual space 700 is a 3D space represented by three axes of X, Y, and Z intersecting each other. The Z axis is orthogonal to a reference surface 701 equivalent to the ground, and the X axis and the Y axis are parallel to the reference surface 701. For example, the execution unit 213 determines a position P1′ on the virtual space 700 corresponding to the position P1 of the real marker M1 included in the real marker information, and installs the virtual marker M2 at the determined position P1′. The position P1′ is, for example, a front position of the virtual marker M2. At this time, the execution unit 213 determines an orientation D2′ of the virtual marker M2 so as to be the same orientation as the orientation D2 of the real marker M1 included in the real marker information. As a result, the virtual marker M2 is installed such that the orientation D2′ is parallel to the reference surface 701 in the virtual space 700. Note that a coordinate of the position P1′ is determined at an arbitrary position in the coordinate system of the virtual space 700. An example of the arbitrary position is the origin of the coordinate system of the virtual space 700.

Next, the execution unit 213 installs the 3D model 221 in the virtual space 700 with reference to the virtual marker M2 so as to maintain the relative positional relationship between the real marker M1 and the target object 501 based on the reference distance D1 included in the relative position information.

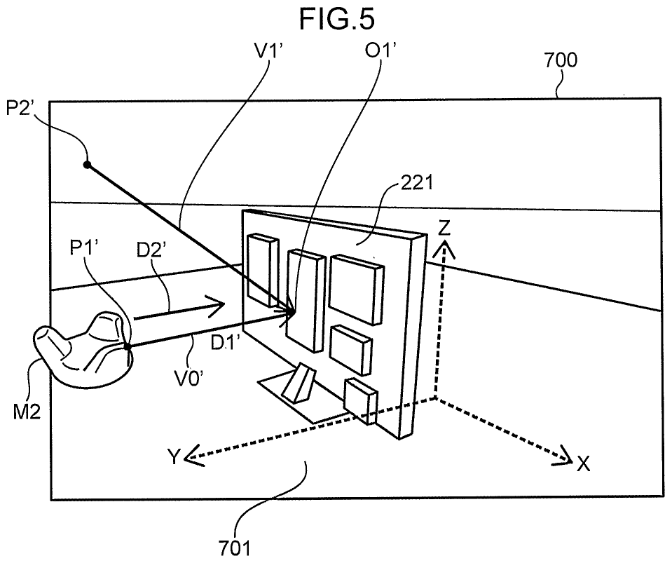

FIG. 5 is a diagram illustrating a state of the spatial calibration subsequent to FIG. 4. The execution unit 213 installs the 3D model 221 in the virtual space 700 such that the 3D model 221 is located at a position separated from the virtual marker M2 by a reference distance D1 in the direction of the orientation D2′. Specifically, the execution unit 213 installs the 3D model 221 such that the direction of the orientation D2′ is parallel to a front direction of the 3D model 221, a center position O1′ of the 3D model 221 is located on a straight line extended from the position P1′ of the virtual marker M2 in the direction of the orientation D2′, and the distance from the position P1′ of the virtual marker M2 to the center position O1′ is the reference distance D1′.

As a result, the virtual marker M2 and the 3D model 221 are installed in the virtual space 700 so as to maintain the positional relationship between the real marker M1 and the target object 501. The position P1′ is a position of the virtual space 700 corresponding to the position P1, the reference distance D1′ is a distance of the virtual space 700 corresponding to the reference distance D1, the orientation D2′ is an orientation of the virtual space 700 corresponding to the orientation D2, and the center position O1′ is a position of the virtual space 700 corresponding to the center position O1.

Next, the execution unit 213 generates calibration information 222 and stores the calibration information 222 in the memory 22. The calibration information 222 includes a real reference vector V0 illustrated in FIG. 3 and a virtual reference vector V0′ illustrated in FIG. 5. The real reference vector V0 is a vector indicating the relative position of the real marker M1 with respect to the target object 501 when the spatial calibration is executed. Specifically, the real reference vector V0 is a vector having the position P1 as a start point and the center position O1 as an end point. The virtual reference vector V0′ is a vector having the position P1′ as a start point and the center position O1′ as an end point in the virtual space 700, and is a vector indicating the relative position of the virtual marker M2 with respect to the 3D model 221.

See FIG. 1 again. The second acquisition unit 214 acquires, in the real space 600, real marker information indicating the position and the orientation of the real marker M1 worn by the worker 504. The real marker information is marker information indicating, by the detection device 1, the position and the orientation of the real marker M1 worn by the worker 504 while the worker 504 is working. The detection device 1 detects the position and the orientation of the real marker M1 at a predetermined sampling rate during the work, and outputs marker information indicating the detected position and orientation to the worker terminal 2 at a predetermined sampling rate. The second acquisition unit 214 acquires the marker information output from the detection device 1 as real marker information during the work of the worker 504. During the work, the worker 504 wears the real marker M1 on the head, for example. However, the head is an example, and the real marker M1 may be worn at a position other than the head of the worker 504.

The synchronization unit 215 synchronizes the position and the orientation of the virtual camera in the virtual space 700 with the position and the orientation of the real marker M1 indicated by the real marker information based on the real marker information.

Referring to FIG. 3, it is assumed that the position of the real marker M1 is located at the position P2 during the work. In this case, the synchronization unit 215 calculates a vector from the position P2 of the real marker M1 included in the real marker information to the center position O1 as a real space vector V1. The real space vector V1 is a vector indicating the relative position of the real marker M1 with respect to the target object 501 during the work. Next, the synchronization unit 215 calculates a difference vector ΔV between the real space vector V1 and the real reference vector V0.

Next, referring to FIG. 5, the synchronization unit 215 adds the difference vector ΔV to the virtual reference vector V0′ in the virtual space 700 to calculate a virtual space vector V1′. The virtual space vector V1′ is a vector indicating the relative position of the virtual marker M2 with respect to the 3D model 221 during the work. Accordingly, the relative position of the working worker with respect to the target object 501 in the real space 600 is reproduced in the virtual space 700. Next, the synchronization unit 215 determines a start point (position P2′) of the virtual space vector V1′ as the position of the virtual camera. Next, the synchronization unit 215 determines the orientation of the real marker M1 included in the real marker information as the orientation of the virtual camera.

See FIG. 1 again. The generation unit 216 generates a virtual camera video indicating the 3D model 221 and captured by the virtual camera synchronized with the real marker M1, and generates output information for displaying an output image including the generated virtual camera video. For example, the generation unit 216 is only required to generate a virtual camera image by setting a virtual screen in the virtual space 700 and rendering the 3D model 221 on the virtual screen. The virtual screen is, for example, a plane that is separated from the virtual camera by a predetermined distance and has a center passing through a line of sight of the virtual camera. The size of the virtual screen is, for example, a size equivalent to a visual field of the worker 504. Accordingly, a virtual camera video in which an image in the visual field of the worker 504 is reproduced is generated. The generation unit 216 generates the virtual camera video at a predetermined sampling rate. As a result, the virtual camera video can reproduce the image of the visual field of the worker 504 in real time.

The output unit 217 transmits the output information generated by the generation unit 216 to the manager terminal 3 by using the communication unit 24.

The memory 22 is, for example, a nonvolatile rewritable storage device such as a flash memory or a solid state drive. The memory 22 stores the 3D model 221 and the calibration information 222.

The display 23 is a liquid crystal display device, for example. The communication unit 24 is a communication circuit for connecting the worker terminal 2 to a network. The communication unit 24 transmits the output information to the manager terminal 3 via the network.

The manager terminal 3 is, for example, a terminal installed at a remote place. The manager terminal 3 includes, for example, a computer including a communication unit, a processor, a display, an operation unit, and the like. The manager terminal 3 may include a desktop computer or a portable computer such as a smartphone or a tablet computer. The processor of the manager terminal 3 causes the display to display an output image drawn based on the output information transmitted from the worker terminal 2.

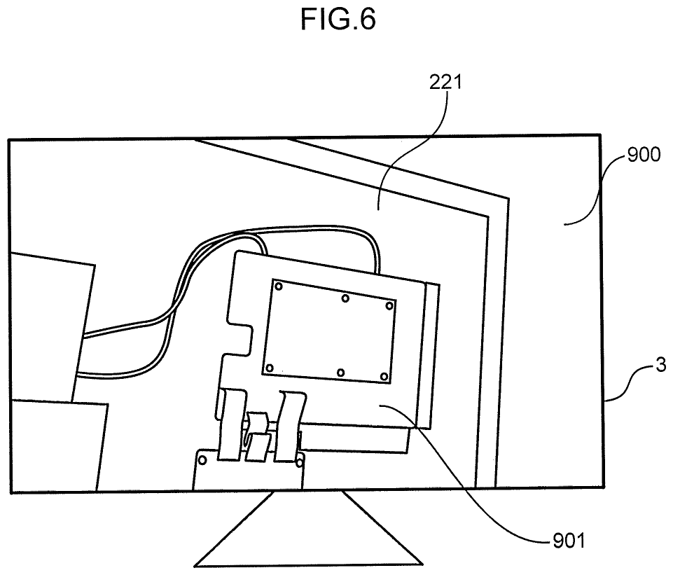

FIG. 6 is a diagram illustrating an example of a virtual camera video 900 included in the output image. The virtual camera video 900 is displayed on the display of the manager terminal 3. The virtual camera video 900 includes a video of the 3D model 221. The video of the 3D model 221 is obtained by drawing an image of the target object 501 when the target object 501 in the visual field of the worker 504 is viewed from the line-of-sight direction of the worker 504 by using the 3D model 221. As a result, the manager 514 can confirm the image of the target object 501 visually recognized by the worker 504, and can smoothly instruct the worker 504.

In FIG. 6, the portion of the circuit board may be the movable portion 901 of the 3D model 221. In this case, when the manager 514 inputs operation information indicating an operation on the movable portion 901 to the manager terminal 3, the manager terminal 3 transmits the operation information to the worker terminal 2. The processor 21 of the worker terminal 2 that has received the operation information moves the movable portion 901 based on the operation information. Specifically, the generation unit 216 of the processor 21 moves the movable portion 901 according to an operation amount indicated by the operation information. Since the generation unit 216 renders the 3D model 221 at a predetermined sampling rate, the virtual camera video 900 indicating the movement of the movable portion 901 in real time is displayed on the manager terminal 3. Examples of the movement of the movable portion 901 include a movement of detaching the movable portion 901 from a body of the 3D model 221.

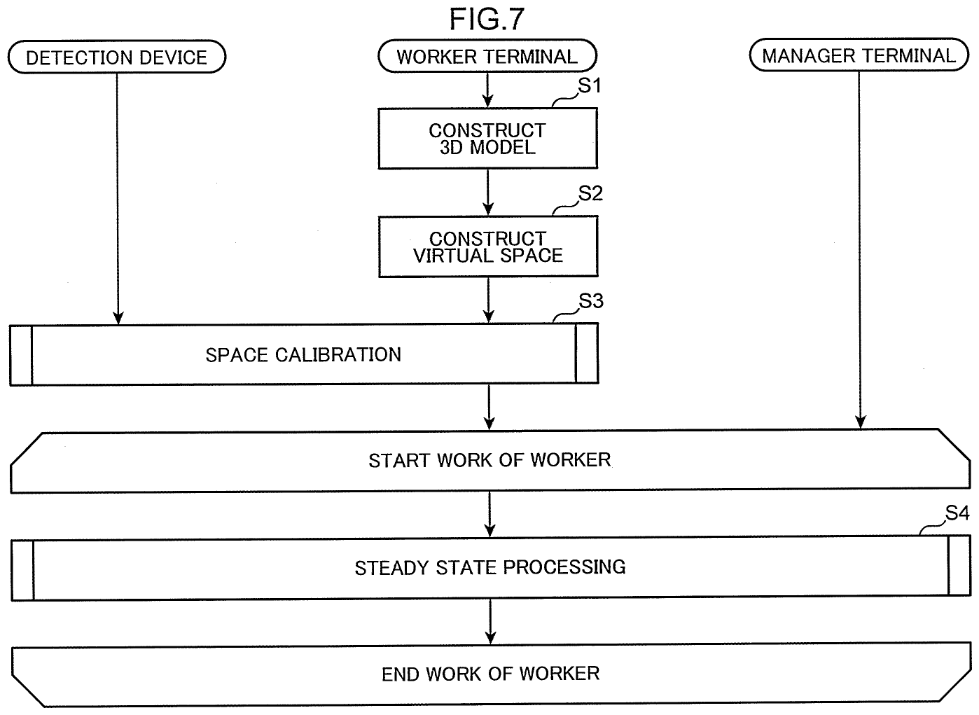

The configuration of the information processing system 100 has been described above. Next, the processing of the information processing system 100 will be described. FIG. 7 is a flowchart illustrating an overview of the processing of the information processing system 100.

The construction unit 211 of the worker terminal 2 constructs the 3D model 221 (step S1). Next, the construction unit 211 constructs the virtual space 700 having a coordinate system of three axes of X, Y, and Z in the computer (step S2).

Next, the detection device 1 and the worker terminal 2 execute spatial calibration of associating the real space 600 with the virtual space 700 (step S3). Next, from the start to the end of the work by the worker 504 at the site, the information processing system 100 generates the virtual camera video 900 and executes steady state processing of displaying the generated virtual camera video 900 on the manager terminal 3 in real time (step S4).

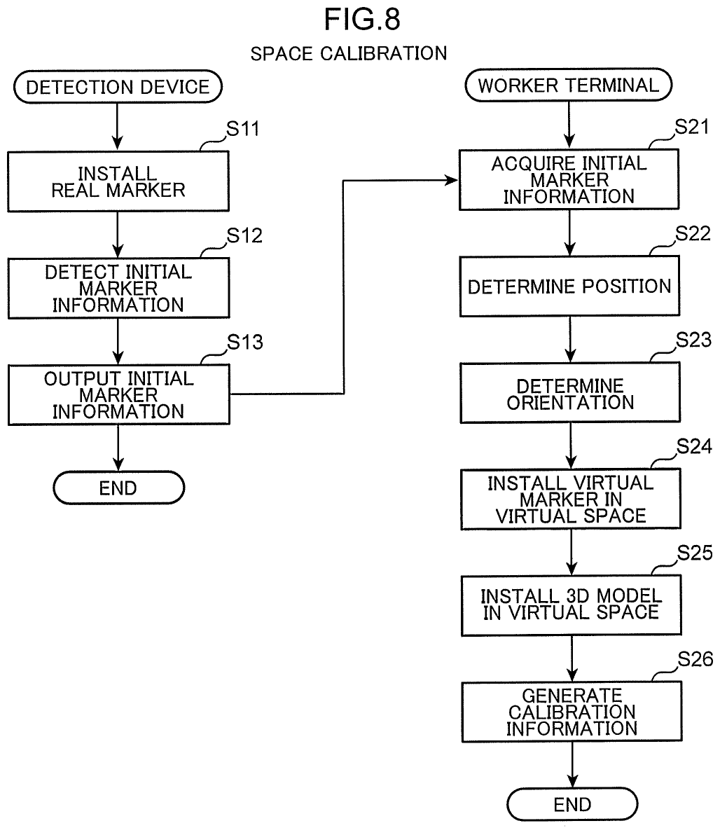

FIG. 8 is a flowchart illustrating details of processing of the spatial calibration. In step S11, the real marker M1 is installed in the real space 600 by the worker 504. In this case, as illustrated in FIG. 3, the real marker M1 is installed at a position separated from the target object 501 by the reference distance D1 and at the reference height h from the ground.

In this installation, for example, in a state where the target object 501 is not installed, for example, the worker 504 installs an optical tracker at a position equivalent to the center position O1. Then, for example, while confirming a measured value of the optical tracker, the worker 504 may position the real marker M1 so as to install the real marker M1 at a position separated from the center position O1 by the reference distance D1 and at the reference height h. Alternatively, while confirming a measured value of a depth sensor installed in the real space 600, the worker 504 may position the real marker M1 so as to install the real marker M1 at a position separated from the center position O1 by the reference distance D1 and at the reference height h.

Next, in step S12, the detection device 1 detects the initial marker information by detecting the position P1 and the orientation D2 of the real marker M1. Then, in step S13, the detection device 1 outputs the initial marker information to the worker terminal 2 via the communication channel C1.

Subsequently, in step S21, the first acquisition unit 212 of the worker terminal 2 acquires the initial marker information by using the communication unit 24.

Next, in step S22, the execution unit 213 determines the position P1′ on the virtual space 700 corresponding to the position P1 of the real marker M1 included in the initial marker information. In the first embodiment, the position P1′ is an arbitrary position (for example, an origin or the like) on the virtual space 700, and is not limited.

Next, in step S23, the execution unit 213 determines the orientation D2′ on the virtual space 700 corresponding to the orientation D2 of the real marker M1 included in the initial marker information.

Next, in step S24, the execution unit 213 installs the virtual marker M2 in the virtual space 700 such that the virtual marker M2 takes the orientation D2′ determined in step S23 at the position P1′ determined in step S22. Accordingly, the virtual marker M2 is installed in the virtual space 700 as illustrated in FIG. 4.

Next, in step S25, the execution unit 213 determines a position separated from the virtual marker M2 by the reference distance D1 in the direction of the orientation D2′, and installs the 3D model 221 such that the center position O1′ is located at the determined position.

Next, in step S26, the execution unit 213 calculates the real reference vector V0 illustrated in FIG. 3, calculates the virtual reference vector V0′ illustrated in FIG. 5, and generates the calibration information 222 including the real reference vector V0 and the virtual reference vector V0′ having been calculated. The generated calibration information 222 is stored in the memory 22.

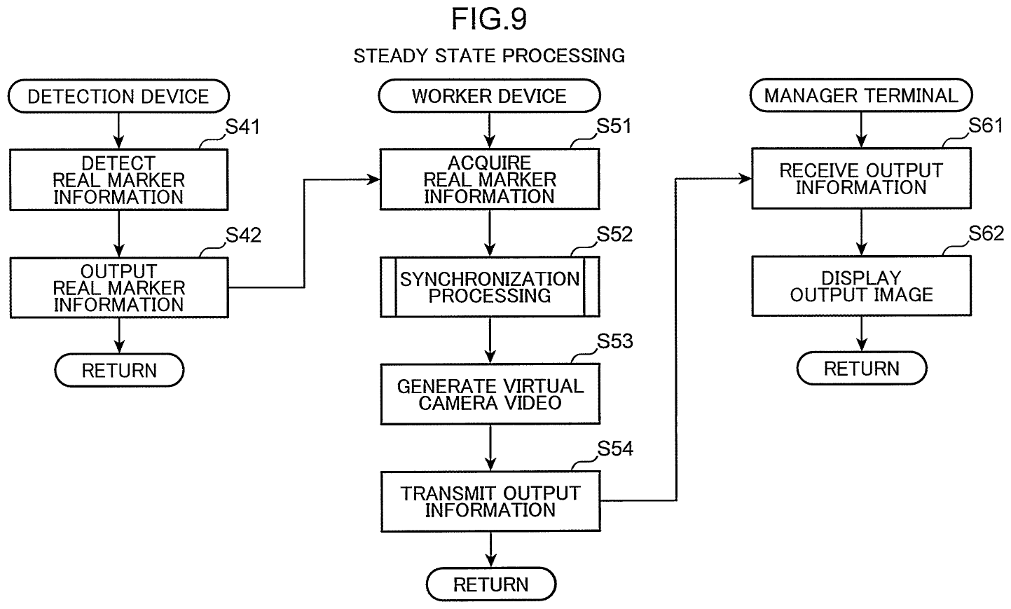

Then, the spatial calibration ends. Next, the steady state processing will be described. FIG. 9 is a flowchart illustrating details of the steady state processing. The steady state processing starts, for example, when the worker 504 inputs a command notifying a start of work to the worker terminal 2 and the worker terminal 2 acquires the input command. Alternatively, the steady state processing starts, for example, when the manager 514 inputs a command notifying a start of the work to the manager terminal 3 and the worker terminal 2 acquires the input command via the manager terminal 3.

In step S41, the detection device 1 detects the real marker information by detecting the position P1 and the orientation D2 of the real marker M1 worn by the worker 504.

Then, in step S42, the detection device 1 outputs the real marker information to the worker terminal 2.

Subsequently, in step S51, the second acquisition unit 414 of the worker terminal 2 acquires the real marker information.

Next, in step S52, the synchronization unit 215 executes synchronization processing. Details of the synchronization processing will be described later.

Next, in step S53, the generation unit 216 generates the virtual camera video 900 indicating the 3D model 221 and captured by the virtual camera synchronized with the real marker M1.

Next, in step S54, the output unit 217 generates output information for displaying the virtual camera video 900, and transmits the generated output information to the manager terminal 3 by using the communication unit 24.

Next, in step S61, the manager terminal 3 receives the output information. In step S62, the manager terminal 3 displays the output image indicating the output information.

The above processing is repeatedly executed at a predetermined sampling rate until the work of the worker ends, and the virtual camera video 900 is displayed on the manager terminal 3 in real time. The steady state processing ends when the worker 504 inputs a command notifying an end of the work to the worker terminal 2 and the worker terminal 2 acquires the command. Alternatively, the steady state processing ends when the manager 514 inputs a command notifying an end of the work to the manager terminal 3 and the worker terminal 2 acquires the command via the manager terminal 3.

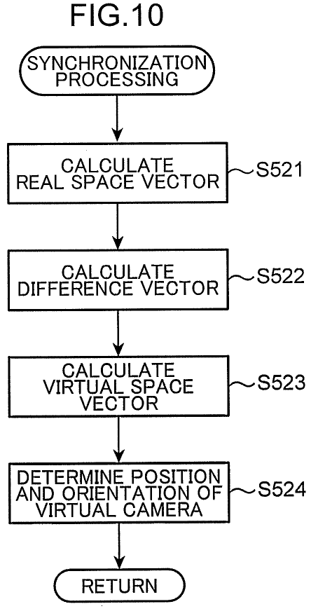

Next, details of the synchronization processing illustrated in step S52 will be described. FIG. 10 is a flowchart illustrating the details of the synchronization processing.

In step S521, the synchronization unit 215 calculates a vector from the position P2 of the real marker M1 included in the real marker information to the center position O1 as the real space vector V1 in the real space 600.

Next, in step S522, the synchronization unit 215 calculates the difference vector ΔV between the real space vector V1 and the real reference vector V0.

Next, in step S523, the synchronization unit 215 adds the difference vector ΔV to the virtual reference vector V0′ in the virtual space 700 to calculate the virtual space vector V1′.

Next, in step S524, the synchronization unit 215 determines the start point (position P2′) in the virtual space vector V1′ as the position of the virtual camera, and determines the orientation of the real marker M1 included in the real marker information as the orientation of the virtual camera. As a result, the position and the orientation of the virtual camera are synchronized with the position and the orientation of the real marker M1 indicated by the real marker information.

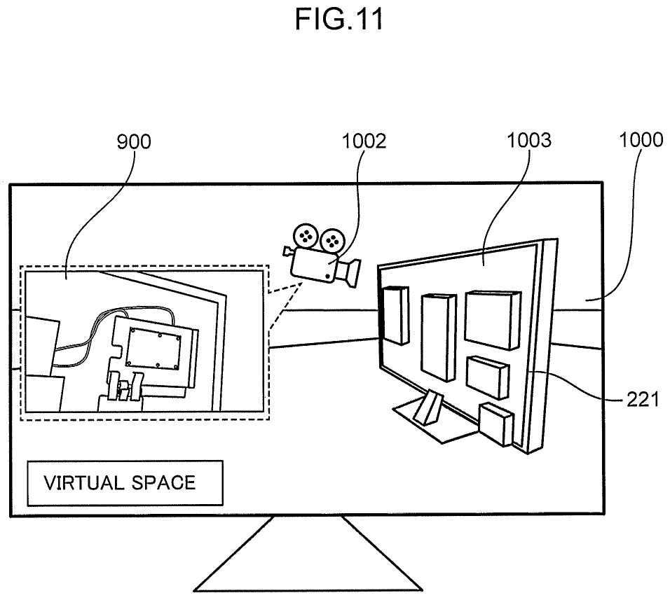

Next, a modification of the output image will be described. The output image may further include an overhead view image overlooking the 3D model 221. FIG. 11 is a diagram illustrating an example of an overhead view image 1000.

The overhead view image 1000 is an image obtained by rendering the virtual space 700 with an overhead view virtual camera that is a virtual camera other than the virtual camera that renders the virtual camera video 900. The overhead view image 1000 includes the virtual camera video 900, a camera icon 1002, and the 3D model 221.

The camera icon 1002 is an icon indicating the position and the orientation of the virtual camera rendering the virtual camera video 900. The camera icon 1002 changes in position and orientation in synchronization with the position and the orientation of the virtual camera. The position and the orientation of the overhead view virtual camera may be changed by an instruction of the manager. In this case, the 3D model 221 in the overhead view image 1000 changes in display mode in accordance with the position and the orientation of the overhead view virtual camera. This configuration can provide the manager with information indicating which part of the target object 501 the worker 504 is looking at in an overhead view.

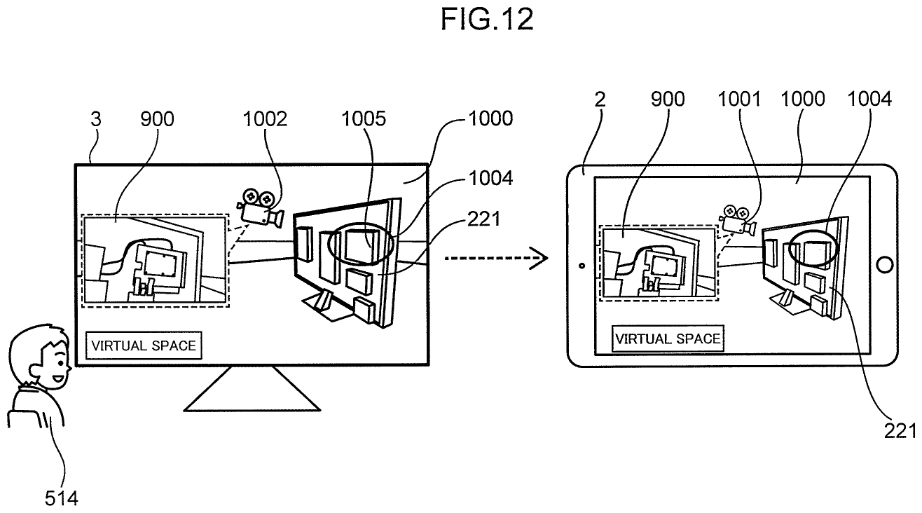

Furthermore, the overhead view image 1000 may be displayed on the worker terminal 2. FIG. 12 is a view illustrating the overhead view image 1000 displayed on each of the manager terminal 3 and the worker terminal 2. In the example of FIG. 12, the overhead view image 1000 further includes a display object 1004.

The display object 1004 is a display object that indicates a position designated by the manager in the overhead view image 1000. The manager 514 operates an operation device (not illustrated) to display the display object 1004 indicating the position designated on the overhead view image 1000. Then, display object information for displaying the display object 1004 on the worker terminal 2 is transmitted from the manager terminal 3 to the worker terminal 2. Accordingly, the worker terminal 2 causes the display object 1004 to be displayed on the overhead view image 1000. In the example of FIG. 12, the display object 1004 is displayed at a display position of the overhead view image 1000 displayed on the worker terminal 2 corresponding to the overhead view image 1000 displayed on the manager terminal 3. As a result, the manager can share the designated position with the worker.

In this manner, in the first embodiment, the manager 514 can confirm the virtual camera video 900 that is the video of the 3D model 221 viewed from the line of sight of the worker 504. As a result, the place looked at by the worker 504 can be confirmed by the remote manager 514 under the condition where a video at the site cannot be output.

Furthermore, in the first embodiment, the initial marker information indicating the position and the orientation of the real marker installed at a predetermined relative position with respect to the target object 501 is acquired, and the spatial calibration of associating the real space 600 with the virtual space 700 is executed based on the initial marker information and the relative position. Therefore, the real space 600 and the virtual space 700 can be accurately associated with each other, and it is therefore possible to generate the virtual camera video 900 in which the place looked at by the worker 504 is accurately reproduced without using a real video of the site.

Furthermore, in the first embodiment, the 3D model is installed in the virtual space with reference to the virtual marker such that the position of the real marker is installed at an arbitrary position in the virtual space 700 and the relative positional relationship between the real marker and the target object is maintained. Therefore, a coordinate system of the virtual space can be set such that the position of the virtual marker substantially becomes an origin, and the position of the target object can be determined by using the coordinate system. Therefore, the real marker and the virtual marker can be accurately associated in an environment using a sensor that represents the position of the real marker by a relative position from the real marker.

### First Modification of First Embodiment

A first modification of the first embodiment is different from the first embodiment in spatial calibration and the synchronization processing. Note that, in the first modification of the first embodiment, the detection device 1 includes a sensor that represents the position of the object in the real space by a 3D coordinate system. An example of this sensor is an optical sensor such as an optical tracker. The 3D coordinate system is represented by the three axes of x, y, and z intersecting each other as illustrated in FIG. 3. In the example of FIG. 3, the z axis intersects the ground and the y axis and the x axis are parallel to the ground. Therefore, the position of the real marker M1 is represented by coordinate data of x, y, and z. The orientation of the real marker M1 is represented by a 3D vector.

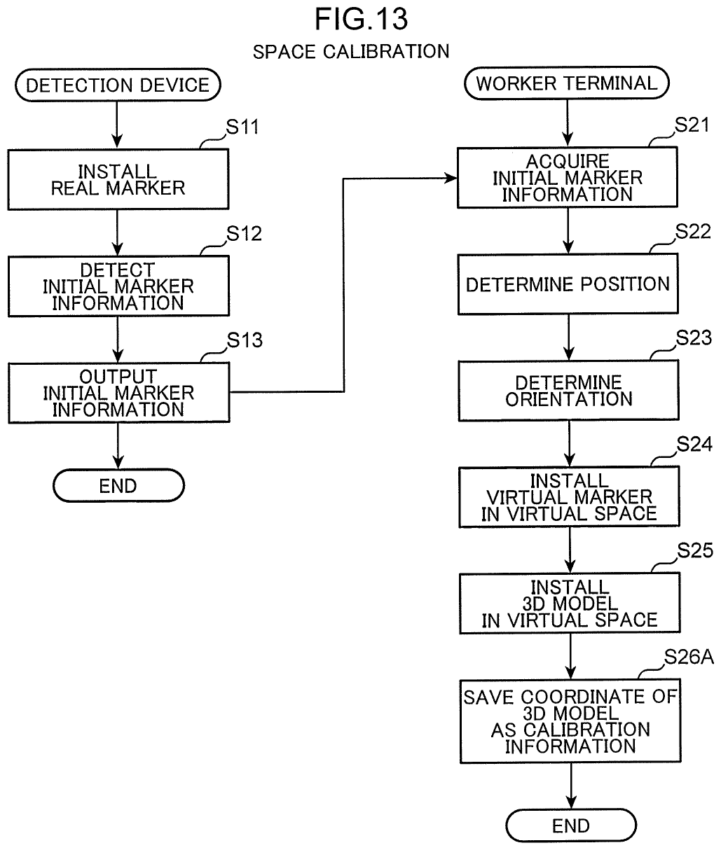

FIG. 13 is a flowchart illustrating processing of spatial calibration in the first modification of the first embodiment. A difference in FIG. 13 from FIG. 8 is step S26A.

In step S25 subsequent to step S26A, the execution unit 213 of the worker terminal 2 generates a coordinate of the 3D model 221 in the virtual space 700 as the calibration information 222, and stores the generated calibration information 222 in the memory 22.

As described with reference to FIG. 8, in the processing of step S25, the coordinate of the 3D model 221 in the virtual space 700 is adjusted such that the distance between the virtual marker M2 and the 3D model 221 in the real space 600 is equal to the distance between the real marker M1 and the target object 501 in the virtual space 700. As a result, the coordinate system of the real space 600 and the coordinate system of the virtual space 700 match. However, the coordinate of the virtual marker M2 is required to generate the virtual camera video during the work. Therefore, in the first modification, the coordinate of the 3D model 221 installed in the virtual space 700 is stored as the calibration information in the memory 22.

See FIG. 5. For example, in FIG. 5, the coordinate of the virtual marker M2 is the position P1′, and the coordinate of the 3D model 221 is the center position O1′. In this case, with reference to FIG. 3, the execution unit 213 adjusts the position of the center position O1′ of the 3D model 221 such that the distance from the real marker M1 to the target object 501 is equal to the distance from the virtual marker M2 to the center position O1′ of the 3D model 221. As a result, the positional relationship between the real marker M1 and the target object 501 can be reproduced in the virtual space 700 during the work.

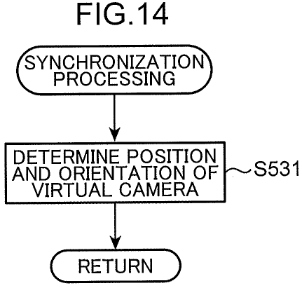

Next, the synchronization processing in the first modification of the first embodiment will be described. FIG. 14 is a flowchart illustrating an example of the synchronization processing in the first modification of the first embodiment. In step S531, the synchronization unit 215 determines the position and the orientation of the virtual camera based on the real marker information acquired in step S51 (FIG. 9). As illustrated in FIG. 3, when the position of the real marker M1 included in the real marker information is the position P2, the coordinate of the position P2 is plotted in the virtual space 700, and the plotted coordinate is determined as the position P2′ of the virtual marker M2. In addition, the orientation of the real marker M1 included in the real marker information is determined as the orientation of the virtual marker M2. Then, the synchronization unit 215 determines the position P2′ of the virtual marker M2 as the position of the virtual camera, and determines the orientation of the virtual marker M2 as the orientation of the virtual camera. As a result, the position and the orientation of the real marker M1 are synchronized with the position and the orientation of the virtual camera. When step S531 ends, the processing proceeds to step S53 (FIG. 9).

In this manner, in the first modification of the first embodiment, since the spatial calibration is performed to coincide the coordinate system in the real space 600 with the coordinate system in the virtual space 700, the position and the orientation of the virtual marker M2 can be set by directly using the position and the orientation indicated by the real marker information.

Furthermore, in the first modification of the first embodiment, since the spatial calibration is performed such that the coordinate system in the real space coincides with the coordinate system in the virtual space, the position and the orientation of the virtual marker can be set by directly using the position and the orientation indicated by the real marker information in an environment where the position of the real marker is detected by using a sensor that represents the position of the object by the coordinate system in the real space.

### Second Modification of First Embodiment

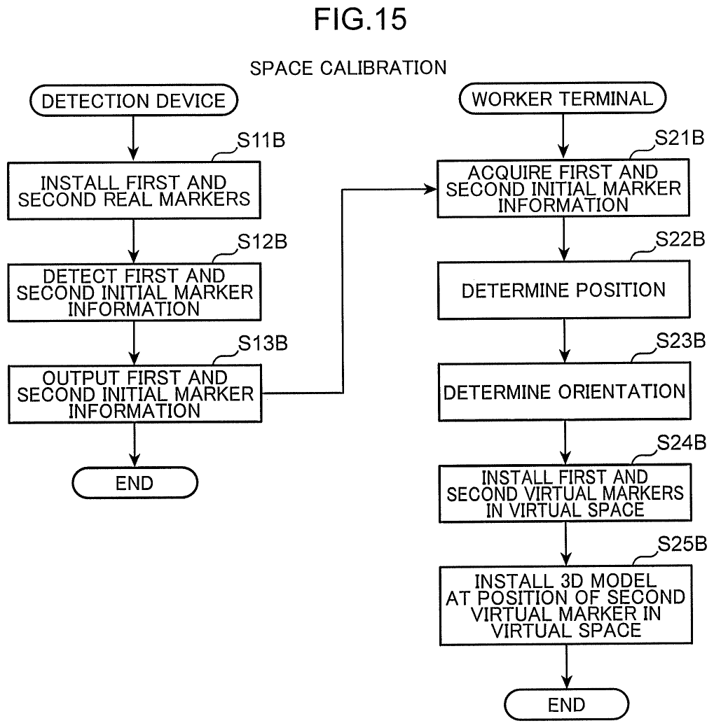

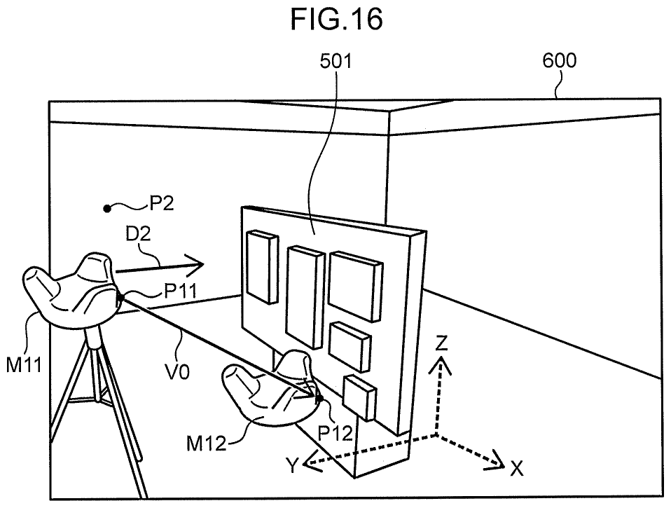

In a second modification of the first embodiment, the spatial calibration is performed by using the first real marker and the second real marker. FIG. 15 is a flowchart illustrating processing of the spatial calibration in the second modification of the first embodiment. FIGS. 16 17, and 18 are explanatory diagrams of processing in the second modification of the first embodiment.

In step S11B, as illustrated in FIG. 16, the worker 504 installs a first real marker M11 and a second real marker M12 in the real space 600. The first real marker M11 is installed at a position different from the position of the target object 501. The second real marker M12 is installed at the position of the target object 501. Specifically, the second real marker M12 is installed near the target object 501. This position of the second real marker M12 is regarded as the position of the target object 501.

Next, in step S12B, the detection device 1 detects first initial marker information by detecting the position P11 and the orientation D2 of the first real marker M11 and detects second initial marker information by detecting a position P12 and an orientation (not illustrated) of the second real marker M12.

Next, in step S13B, the detection device 1 outputs the first initial marker information and the second initial marker information to the worker terminal 2 via the communication channel C1.

Subsequently, in step S21B, the first acquisition unit 212 of the worker terminal 2 acquires the first initial marker information and the second initial marker information by using the communication unit 24.

Next, in step S22B, the execution unit 213 determines a position P11′ on the virtual space 700 corresponding to the position P11 of the first real marker M11 included in the first initial marker information and determines a position P12′ on the virtual space 700 corresponding to the position P12 of the second real marker M12 included in the second initial marker information. For example, the execution unit 213 is only required to calculate the relative position of the second real marker M12 with respect to the first real marker M11 in the real space 600, and determine the position of a second virtual marker M22 with respect to a first virtual marker M21 such that the relative positional relationship between the first real marker M11 and the second real marker M12 is maintained based on the relative position. In this case, the execution unit 213 is only required to calculate a vector having the position P11 as a start point and the position P12 as an end point as the relative position of the second real marker M12 with respect to the first real marker M11.

Next, in step S23B, the execution unit 213 determines the orientation D2′ on the virtual space 700 corresponding to the orientation D2 of the first real marker M11 included in the first initial marker information, and determines the orientation (not illustrated) on the virtual space 700 corresponding to the orientation (not illustrated) of the second real marker M12 included in the second initial marker information.

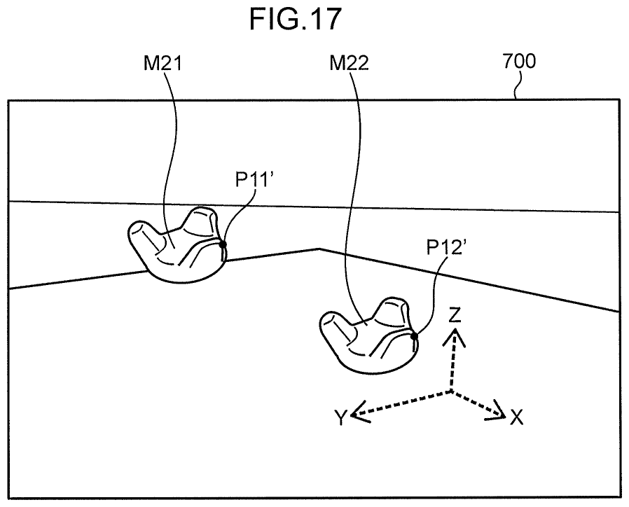

Then, in step S24B, the execution unit 213 installs the first virtual marker M21 in the virtual space 700 such that the first virtual marker M21 takes the orientation D2′ determined in step S23 at the position P11′ determined in step S22B. Furthermore, the execution unit 213 installs the second virtual marker M22 in the virtual space 700 such that the second virtual marker M22 takes the orientation (not illustrated) determined in step S23B at the position P12′ determined in step S22B. Accordingly, the virtual marker M2 is installed in the virtual space 700 as illustrated in FIG. 17.

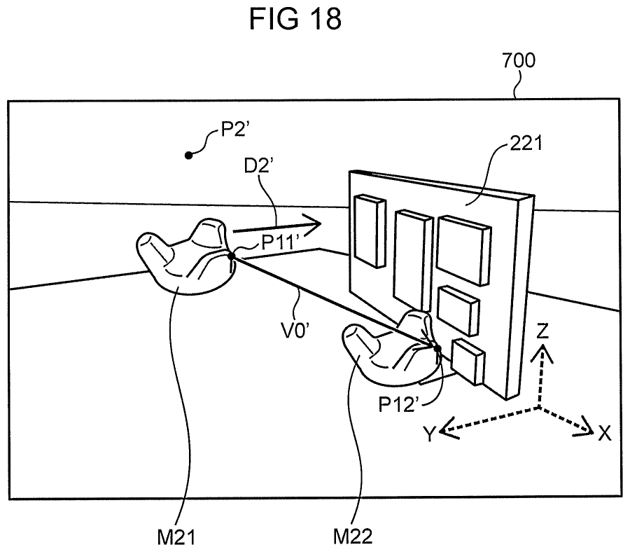

Next, in step S25B, the execution unit 213 installs the 3D model 221 at the position P12′ of the second virtual marker M22 as illustrated in FIG. 18. Specifically, the execution unit 213 installs the 3D model 221 such that a predetermined position of the 3D model 221 is positioned at the position P12′ and a main surface of the 3D model 221 intersects the orientation D2′ of the first virtual marker M21. As a result, the 3D model is installed in the virtual space 700 so as to maintain the relative positional relationship between the first real marker M11 and the target object 501.

In the second modification, since the coordinate system of the real space 600 and the coordinate system of the virtual space 700 coincide with each other in the stage of step S25B, and furthermore, the position of the target object 501 is constantly updated by the second real marker M12, the calibration information is not required to be stored.

The synchronization processing in the second modification of the first embodiment is the same as the synchronization processing in the first modification of the first embodiment illustrated in FIG. 14, and thus will not be described in detail. The coordinate of the position P2 of the first real marker M11 worn by the worker 504 as illustrated in FIG. 16 is determined as the position P2′ of the first virtual marker M21 in the virtual space 700 as illustrated in FIG. 18. Furthermore, the orientation of the first real marker M11 is determined as the orientation of the first virtual marker M21. Then, the determined position P2′ of the first virtual marker M21 is determined as the position of the virtual camera, the orientation of the first virtual marker M21 is determined as the orientation of the virtual camera, and the virtual camera video is captured.

In this manner, in the second modification of the first embodiment, since the spatial calibration is performed by the first real marker M11 and the second real marker M12, time and effort of generating calibration information can be saved.

### Second Embodiment

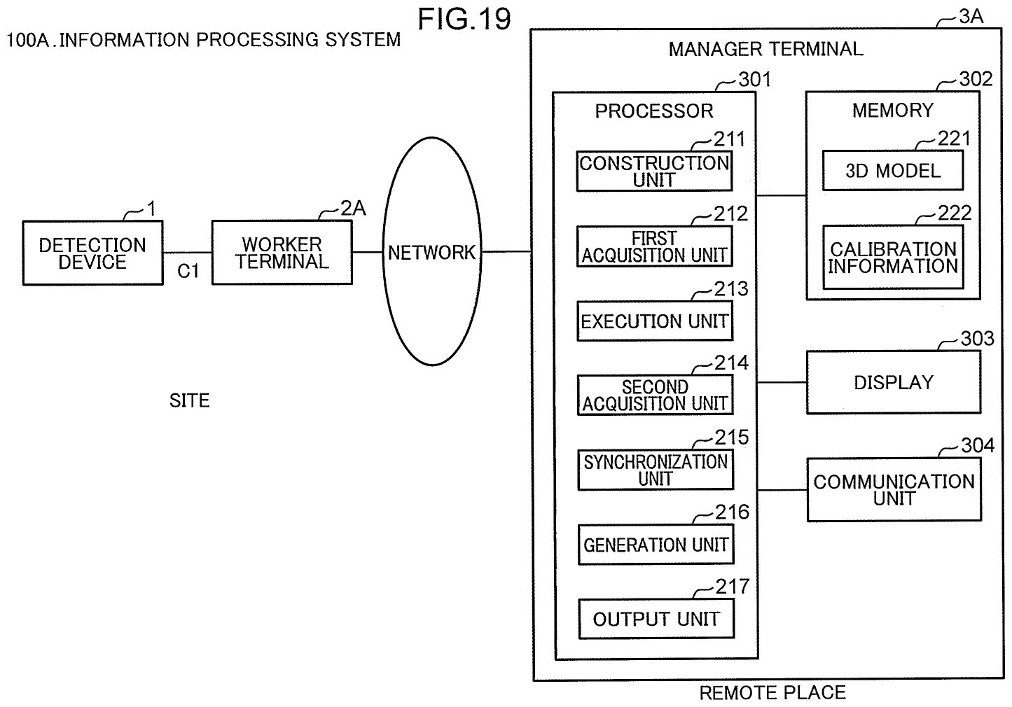

FIG. 19 is a block diagram illustrating an example of a configuration of an information processing system 100A according to a second embodiment. In the first embodiment, the worker terminal 2 is a processing subject, but in the second embodiment, a manager terminal 3A is the processing subject. The information processing system 100A includes the detection device 1, a worker terminal 2A, and the manager terminal 3A.

In the first embodiment, the processor 21 of the worker terminal 2 includes the construction unit 211, the first acquisition unit 212, the execution unit 213, the second acquisition unit 214, the synchronization unit 215, the generation unit 216 and the output unit 217. However, in the second embodiment, a processor 301 of the manager terminal 3A includes these configuration. In the first embodiment, the memory 22 stores the 3D model 221 and the calibration information 222. However, in the second embodiment, a memory 302 includes these configurations.

The manager terminal 3A includes the processor 301, the memory 302, a display 303, and a communication unit 304. The processor 301 includes, for example, a central processing unit. The construction unit 211, the first acquisition unit 212, the execution unit 213, the second acquisition unit 214, the synchronization unit 215, the generation unit 216 and the output unit 217 are implemented by the processor 301 executing the information processing program. However, these configurations are one example, and may be configured by a dedicated hardware circuit.

The display 303 is, for example, a liquid display device or the like, and displays the virtual camera video 900.

The communication unit 304 is a communication circuit for connecting the manager terminal 3A to a network. The communication unit 304 receives the initial marker information and the real marker information transmitted from the worker terminal 2A.

Next, the processing of the information processing system 100A according to the second embodiment will be described. In the second embodiment, an overview of the processing of the information processing system 100A is the same as in FIG. 7, and will not be described in detail. Instead, FIG. 7 is to be referred to. However, in the second embodiment, the processing of constructing the 3D model (step S1) and the processing of constructing the virtual space (step S2) are performed by the manager terminal 3A, and the processing of the spatial calibration (step S3) is performed by the detection device 1, the worker terminal 2A, and the manager terminal 3A.

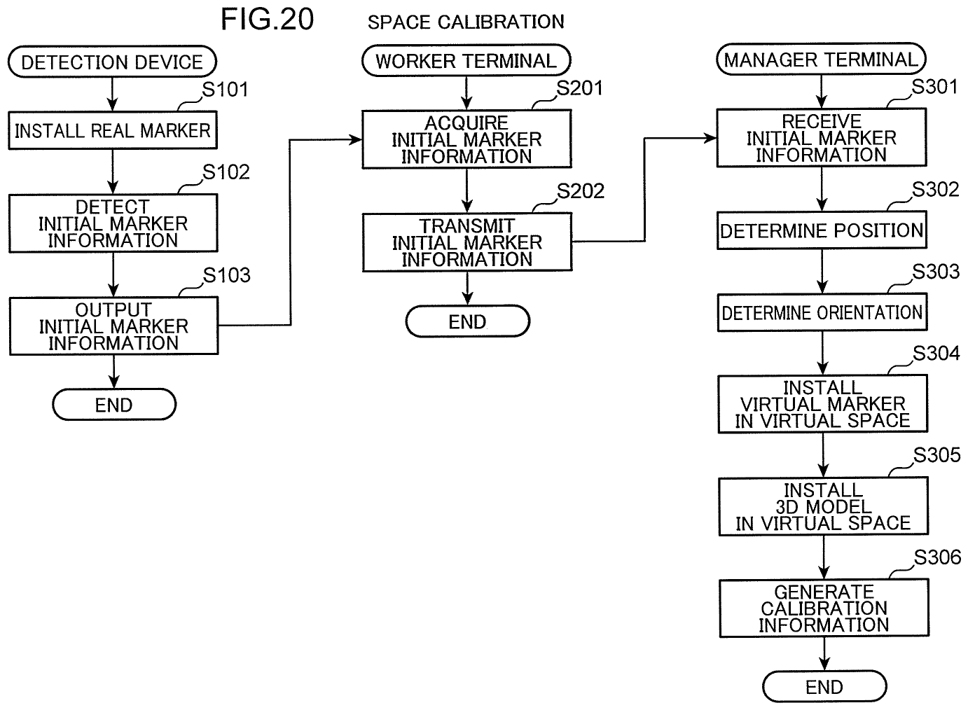

FIG. 20 is a flowchart illustrating details of the processing of the spatial calibration according to the second embodiment.

The processing in steps S101, S102, S103, and S202 is the same as the processing in steps S11, S12, S13, and S21 illustrated in FIG. 8, and will not be described in detail.

In step S202 subsequent to step S201, the worker terminal 2A transmits the initial marker information to the manager terminal 3A. In step S301, the manager terminal 3A receives the initial marker information.

Hereinafter, the processing of steps S302 to S306 will be executed. The processing in steps S302, S303, S304, S305, and S306 is the same as the processing in steps S22, S23, S24, S25, and S26 illustrated in FIG. 8, and will not be described in detail. However, in steps S302 to S306, the processing subject is not the worker terminal 2 but the manager terminal 3A, which is different from FIG. 8.

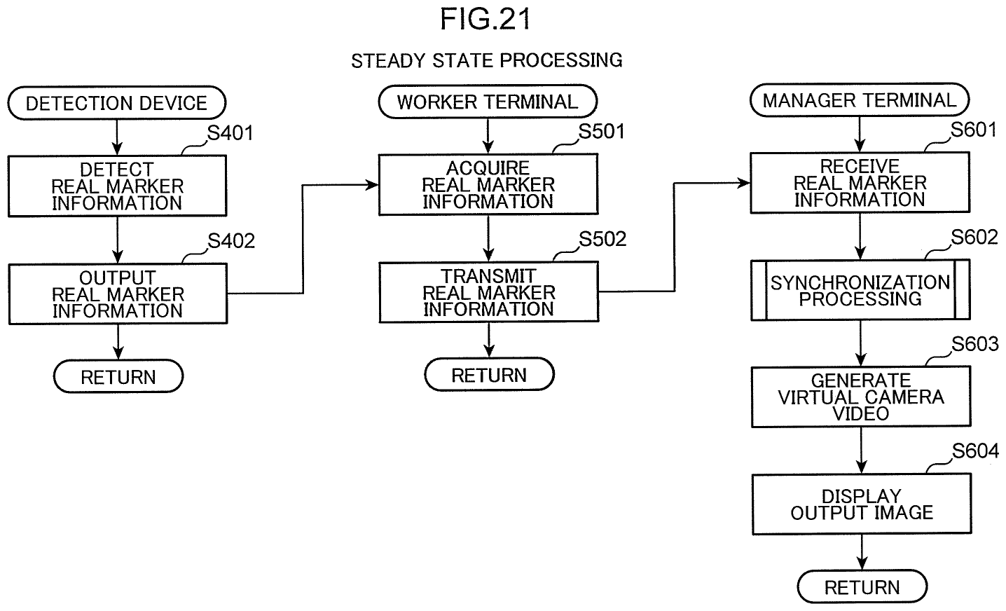

FIG. 21 is a flowchart illustrating details of the steady state processing according to the second embodiment. The processing in steps S401, S402, and S501 is the same as the processing in steps S41, S42, and S51 illustrated in FIG. 9, and will not be described in detail.

In step S502 subsequent to step S501, the worker terminal 2A transmits the real marker information to the manager terminal 3A. In step S601, the communication unit 304 of the manager terminal 3A receives the real marker information.

Hereinafter, the processing of steps S602 to S604 will be executed. Details of the processing of steps S602, S603, and S604 are the same as the details of steps S52, S53, and S62 illustrated in FIG. 9. However, in steps S602 and S603, the processing subject is not the worker terminal 2 but the manager terminal 3A, which is different from FIG. 9. Since the virtual camera video 900 is generated by the manager terminal 3A, the processing of transmitting and receiving the output information illustrated in steps S54 and S61 in FIG. 9 is omitted in FIG. 21.

In this manner, in the second embodiment, when the processing subject is the manager terminal 3A, an effect similar to the effect in the first embodiment can be obtained.

### Third Embodiment

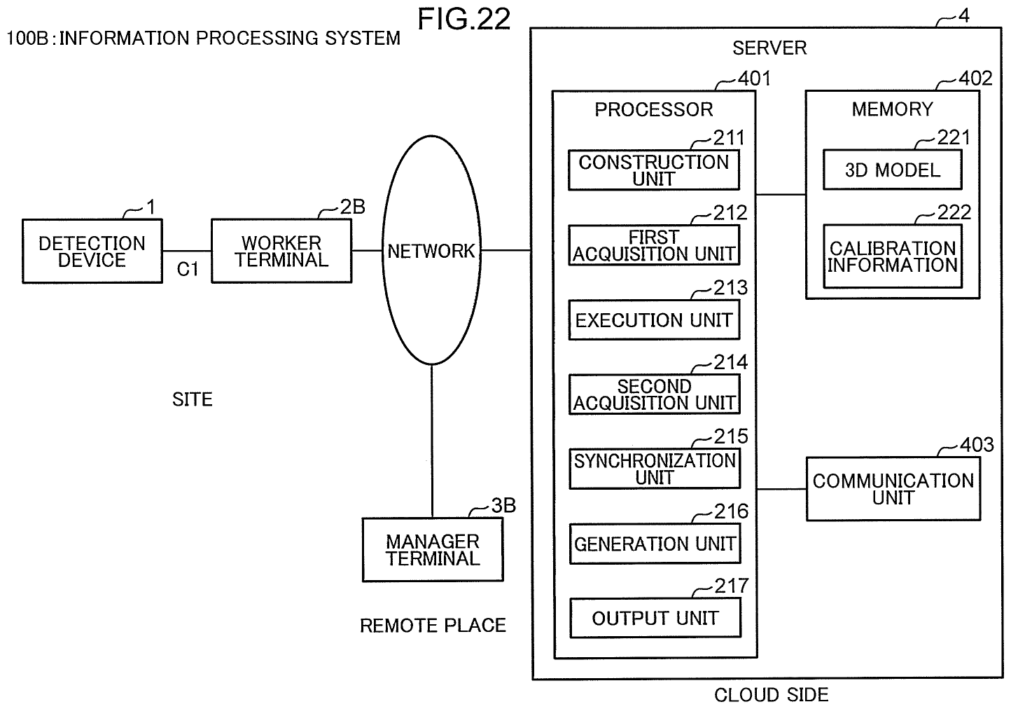

In the first embodiment, the worker terminal 2 is a processing subject, but in a third embodiment, a server is the processing subject. FIG. 22 is a block diagram illustrating an example of a configuration of an information processing system 100B according to the third embodiment. The information processing system 100B includes the detection device 1, a worker terminal 2B, a manager terminal 3B, and the server 4.

The server 4 is a cloud server including one or a plurality of computers, for example. In the first embodiment, the processor 21 of the worker terminal 2 includes the construction unit 211, the first acquisition unit 212, the execution unit 213, the second acquisition unit 214, the synchronization unit 215, the generation unit 216 and the output unit 217. However, in the third embodiment, a processor 401 of the server 4 includes these configuration. In the first embodiment, the memory 22 stores the 3D model 221 and the calibration information 222. However, in the third embodiment, a memory 402 includes these configurations.

The server 4 includes the processor 401, the memory 402, and a communication unit 403. The processor 401 includes, for example, a central processing unit. The construction unit 211, the first acquisition unit 212, the execution unit 213, the second acquisition unit 214, the synchronization unit 215, the generation unit 216 and the output unit 217 are implemented by the processor 401 executing the information processing program. However, these configurations are one example, and may be configured by a dedicated hardware circuit.

The communication unit 403 is a communication circuit for connecting the worker terminal 2 to a network. The communication unit 403 receives the initial marker information and the real marker information transmitted from the worker terminal 2B.

Next, the processing of the information processing system 100B according to the third embodiment will be described. In the third embodiment, an overview of the processing of the information processing system 100B is the same as in FIG. 7, and will not be described in detail. Instead, FIG. 7 is to be referred to. However, in the third embodiment, the processing of performing the 3D model (step S1) and the processing of constructing the virtual space (step S2) are performed by the server 4, and the spatial calibration processing (step S3) and the steady state processing (step S4) are performed by the detection device 1, the worker terminal 2B, and the server 4.

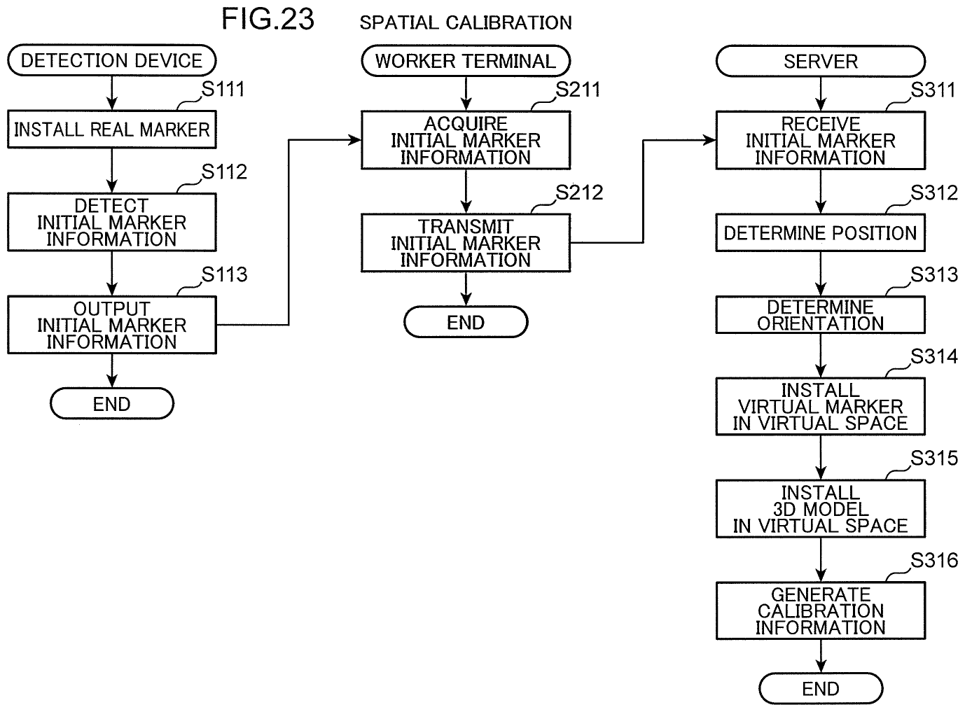

FIG. 23 is a flowchart illustrating details of the processing of the spatial calibration according to the third embodiment.

The processing in steps S111, S112, S113, and S211 is the same as the processing in steps S11, S12, S13, and S21 illustrated in FIG. 8, and will not be described in detail.

In step S212 subsequent to step S211, the worker terminal 2B transmits the initial marker information to the server 4. In step S311, the server 4 receives the initial marker information.

Hereinafter, the processing of steps S312 to S316 will be executed. Details of the processing in steps S312, S313, S314, S315, and S316 are the same as in steps S22, S23, S24, S25, and S26 illustrated in FIG. 8, and will not be described in detail. However, in steps S312 to S316, the processing subject is not the worker terminal 2 but the server 4, which is different from FIG. 8.

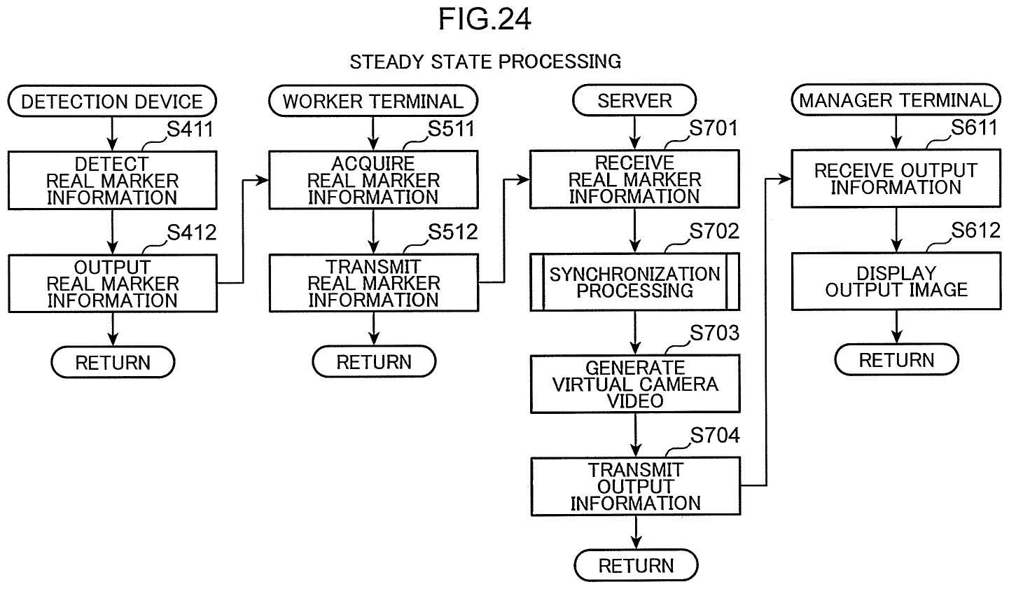

FIG. 24 is a flowchart illustrating details of the steady state processing according to the third embodiment. The processing in steps S411, S412, and S511 is the same as the processing in steps S41, S42, and S51 illustrated in FIG. 9, and will not be described in detail.

In step S512 subsequent to step S511, the worker terminal 2B transmits the real marker information to the server 4. In step S701, the first acquisition unit 212 of the server 4 acquires the real marker information by using the communication unit 403.

Hereinafter, the processing of steps S702 to S704 will be executed. Details of the processing of steps S702 and S703 are the same as the details of steps S52 and S53 illustrated in FIG. 9.

In step S704 subsequent to step S703, the output unit 217 of the server 4 transmits output information including the virtual camera video to the manager terminal 3B.

Next, in step S611, the manager terminal 3B receives the output information. Then, in step S612, the manager terminal 3B displays the output information.

In this manner, in the third embodiment, when the processing subject is the server 4, an effect similar to the effect in the first embodiment can be obtained.

Modifications described below can be adopted in the present disclosure.
(1) The processing of the modification of the first embodiment illustrated in FIG. 13 of the first embodiment may be adopted as the spatial calibration processing in the second and third embodiments.
(2) In the first to third embodiments, the real marker and the virtual marker are used as one example of a mode of detecting a position and an orientation of a user. However, the present disclosure is not limited to this example. For example, in the present disclosure, a mode of directly detecting the position and the orientation of the user by using the detection device 1 may be adopted.

The present disclosure is useful in a remote support system that supports a work of a worker from a remote place.

1. An information processing method in an information processing system that supports a work of a worker, the method comprising:
constructing, in a virtual space, a three-dimensional (3D) model of a target object to be worked on by the worker in a real space;
acquiring position information and orientation information of the worker in the real space;
synchronizing a position and an orientation of a virtual camera in the virtual space with a position and an orientation of the worker based on the position information and the orientation information;
generating a virtual camera video indicating the 3D model captured by the virtual camera synchronized; and
outputting output information for displaying an output image including the virtual camera video.

2. The information processing method according to claim 1, wherein
the position information and the orientation information are real marker information indicating a position and an orientation of a real marker worn by the worker, and
the method further comprises:
acquiring initial marker information indicating a position and an orientation of the real marker installed in the real space;
executing spatial calibration that associates the real space with the virtual space based on the initial marker information and a relative position of the target object and the real marker;
acquiring the real marker information indicating the position and the orientation of the real marker worn by the worker in the real space; and
synchronizing the position and the orientation of the virtual camera with the position and the orientation of the real marker indicated by the real marker information based on the real marker information.

3. The information processing method according to claim 2, wherein
the spatial calibration includes
installing a virtual marker corresponding to the real marker at an arbitrary position in the virtual space based on the initial marker information,
installing the 3D model in the virtual space with reference to the virtual marker so as to maintain a relative positional relationship between the real marker and the target object based on the relative position, and
generating calibration information including a real reference vector indicating a relative position of the real marker with respect to the target object when the spatial calibration is executed and a virtual reference vector indicating a relative position of the virtual marker with respect to the 3D model.

4. The information processing method according to claim 3, wherein
the synchronizing includes
calculating a real space vector indicating a relative position of the real marker with respect to the target object based on the real marker information,
calculating a difference vector between the real space vector and the real reference vector,
determining a position of the virtual marker with respect to the 3D model based on the virtual reference vector and the difference vector and determining an orientation of the virtual marker based on the orientation of the real marker included in the real marker information,
determining the position of the virtual marker as the position of the virtual camera, and
setting the orientation of the virtual marker as the orientation of the virtual camera.

5. The information processing method according to claim 3, wherein the initial marker information and the real marker information are information acquired by using a method of sensing a surrounding environment and detecting a relative position of the initial marker information and the real marker information.

6. The information processing method according to claim 2, wherein
the spatial calibration includes
installing a virtual marker corresponding to the real marker in the virtual space based on the initial marker information,
installing the 3D model in the virtual space so as to maintain the relative positional relationship between the real marker and the target object based on the relative position, and
generating, as the calibration information, a coordinate of the 3D model installed.

7. The information processing method according to claim 6, wherein
the synchronizing includes
determining the position of the real marker as the position of the virtual camera, and
determining the orientation of the real marker as the orientation of the virtual camera.

8. The information processing method according to claim 6, wherein the initial marker information and the real marker information are information acquired by using a sensor representing a position of an object by using a coordinate system of the real space.

9. The information processing method according to claim 2, wherein
the initial marker information includes first initial marker information indicating a position and an orientation of a first real marker installed at a position different from a position of the target object, and second initial marker information indicating a position and an orientation of a second real marker installed at the position of the target object, and
the spatial calibration includes
installing a first virtual marker corresponding to the first real marker in the virtual space based on the first initial marker information,
installing a second virtual marker corresponding to the second real marker in the virtual space so as to maintain a relative positional relationship between the first real marker and the second real marker based on the second initial marker information, and
installing the 3D model at the position of the second real marker.

10. The information processing method according to claim 9, wherein
the synchronizing includes
determining the position of the first real marker as the position of the virtual camera, and
determining the orientation of the first real marker as the orientation of the virtual camera.

11. The information processing method according to claim 1, wherein the virtual camera video further changes in synchronization with a change in the position and the orientation of the virtual camera.

12. The information processing method according to claim 1, wherein
the output image further includes an overhead view image of the 3D model and a camera icon displayed in association with the overhead view image, and
a display mode of the camera icon is changed in synchronization with the position and the orientation of the virtual camera.

13. The information processing method according to claim 12, wherein
the output image is displayed on a worker terminal of the worker and a manager terminal of a manager, and
the method further comprises:
acquiring, from the manager terminal, display object information for displaying a display object indicating a position designated by the manager in the overhead view image or the 3D model indicated in the virtual camera video; and
displaying the display object to be superimposed on the overhead view image or the virtual camera video based on the display object information.

14. The information processing method according to claim 1, wherein
the 3D model includes a body and a movable portion attached to the body, and
the method further comprises acquiring, from the manager terminal, operation information indicating an operation from the manager for the movable portion, and
an image indicating the movable portion included in the virtual camera video changes based on the operation information.

15. The information processing method according to claim 2, wherein the initial marker information and the real marker information are information acquired from a sensor that allows detection of the position and the orientation of the real marker.

16. An information processing device that supports a work of a worker, the information processing device comprising:
a construction unit that constructs, in a virtual space, a three-dimensional (3D) model of a target object to be worked on by the worker in a real space;
a first acquisition unit that acquires position information and orientation information of the worker in the real space;
a synchronization unit that synchronizes a position and an orientation of a virtual camera in the virtual space with a position and an orientation of the worker based on the position information and the orientation information; and
a generation unit that generates a virtual camera video indicating the 3D model captured by the virtual camera synchronized; and
an output unit that outputs output information for displaying an output image including the virtual camera video.

17. A non-transitory computer readable recording medium storing an information processing program that causes a computer to function as an information processing system that supports a work of a worker, the program causing the computer to execute processing of:
constructing, in a virtual space, a three-dimensional (3D) model of a target object to be worked on by the worker in a real space;
acquiring position information and orientation information of the worker in the real space;
synchronizing a position and an orientation of a virtual camera in the virtual space with a position and an orientation of the worker based on the position information and the orientation information;
generating a virtual camera video indicating the 3D model captured by the virtual camera synchronized; and
outputting output information for displaying an output image including the virtual camera video.
